(19) United States
(12) Patent Application Publication
(10) Pub. No.: US 2006/0218248 A1
(43) Pub. Date: Sep. 28, 2006

(54) Contents distribution system, contents distribution method, and computer-readable storage medium therefor

(75) Inventor: Kazuya Shiina, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 11/370,955

(22) Filed: Mar. 9, 2006

(30) Foreign Application Priority Data
Mar. 9, 2005 (JP) P2005-065131

(51) Int. Cl. G06F 15/16

(52) U.S. Cl. 709/219

(57) ABSTRACT

A contents distribution system includes: a distributing server storing broadcast program data including to-be-distributed contents; a distributing-site apparatus receiving the broadcast program data, the distributing-site apparatus comprising a configuration setting file for a display apparatus and/or an external source controlled by the distributing-site apparatus; and a control server providing a unit controlling the distributing-site apparatus over a communication line. In an execution routine of a broadcast program schedule, when a control request for requesting for controlling the display apparatus and/or the external source which is a subject to be controlled, the configuration setting file is interpreted. URL constructed with a character sequence representing a logical configuration is generated from the interpreted configuration setting file. A Web browser is operated to access to the control server to acquire a control I/F component. The display apparatus and/or external source is controlled to reproduce the received broadcast program data.

### CROSS-REFERENCE TO RELATED APPLICATIONS

This application is based on and claims the benefit of priority from the prior Japanese Patent Application No. 2005-65131, filed on Mar. 9, 2005; the entire contents of which are incorporated herein by reference.

### TECHNICAL FIELD

The present invention relates to a contents distribution system, a contents distribution method, and a computer-readable storage medium therefor.

### BACKGROUND

There have been proposed contents distribution systems for distributing image information using large-sized display apparatus disposed at a shop or a street through a communication line such as the Internet.

As broadband lines have widely used for IT (information technology) industries, new advertisement distribution methods of distributing images or moving pictures on display apparatus through the network are needed in advertisement industries where advertisement distribution methods using paper media such as posters and leaflets have been conventionally used.

Whole configuration of a conventional contents distribution system will be described with reference to FIG. 1.

FIG. 1 is a use case view showing a broad contents distribution system.

In FIG. 1, 1 denotes a contents distribution service provider, 2 denotes a contents holder or a creator, 3 denotes a distributing-site apparatus, 4 denotes a service user (client), and 5 denotes a spectator.

The contents holder or the creator 2 receives an order of contents production or order of materials for the contents (2c), provides the contents or materials for the contents (2a). The contents distribution service provider 1 discloses a contents site on World-Wide Web (hereinafter, referred to as “Web”) in some cases (2b).

While the contents distribution service provider 1 constructs a distributing-site apparatus (1e), the contents distribution service provider 1 manages a configuration of the distributing-site apparatus (1a).

If necessary, the contents distribution service provider 1 places the order of contents production or the order of materials for the contents (1d), produces a control script in accordance with a required device control (1h), packages scattered contents (1f), generates a schedule (1g), organizes a broadcast program (1c), and distributes the broadcast program to the distributing-site apparatus (1b).

The distributing-site apparatus 3 includes a display terminal and a display apparatus.

The display terminal receives the broadcast program, executes the schedule contained therein (3b), and reproduces the contents.

In case that a content of the contents is Uniform Resource Locator (hereinafter, referred to as “URL”), a Web server on network via communication line (etc. Internet) indicated by the URL is referred (3a). In another case that the content of the contents is an external source, the control script is executed (3c).

The display apparatus and an apparatus (e.c. the external source) are controlled according to the execution of the control script from the display terminal (3e and 3f), and displays the contents (3d).

The contents distribution service user 4 sends a request for broadcast program to the contents distribution service provider (4a).

The spectator 5 views the contents displayed by the display apparatus (5a).

The contents distribution system provides all the tasks associated with content distribution business in a one-stop manner.

A broadcast program is edited and distributed by the contents distribution service provider. The broadcast program is constructed with contents, a control script, and schedule.

The contents are mainly classified into “contents file” (e.c. a still image, a moving image, a text for telop, and program) and “contents URL” referring to a Web server on network via communication line (e.c. Internet), and “external source” (e.c. TV broadcast or VTR/DVD players).

The control scripts mainly perform a control of the display apparatus of the distribution-site apparatus and a control of the external source, etc., for executing the external source as the contents. Herein, control requirements of the controls calls as “request.” The schedule is configured by “sequence” instructing only an execution order without reference to absolute time and “program” executed in absolute time.

In the aforementioned contents distribution system, since the device configurations of the distributing-site apparatuses in different distributing sites are different from each other, in the contents distribution service provider needs to manage the details of the device configurations as information on the distributing sites and generate the control scripts based on the details of the device configurations at the time of broadcast program editing.

In other words, in a case where the same contents according to the same schedule broadcasted to two or more distributing sites occupied by the same client, if the device configurations are not equal to each other, or if the details of the contents are not equal to each other in a command level, there is a problem in that the same broadcast program editing is not effective.

Now, a hardware configuration of the conventional contents distribution system will be described with reference to FIG. 2.

In the contents distribution system, a distribution server 11 and a distributing-site apparatus 13 are connected through a communication line 15 such as the Internet.

The distribution server 11 includes a hard disk 11a, a CPU 11b, a memory 11c, and a network interface 11d.

The hard disk 11a includes a distribution program and broadcast program data, that is, schedule, contents file, and control script.

The distributing-site apparatus 13 includes a display terminal, a display apparatus, and an external source, etc.

The display terminal includes a hard disk 13a, a CPU 13b, a memory 13c, a network interface 13d, a video/audio interface 13e, and a control interface 13f.

The display apparatus which is a controlled display apparatus or source device includes a video/audio display unit 13g, a control interface 13h, and a power supply module 13i.

The hard disk 13a stores a reproducing program, a Web browser, and broadcast program data, that is, schedule, contents file, and control script.

FIG. 3 shows an example of the broadcast program schedule.

Referring to FIG. 3, the schedule is divided into a schedule sheet and a sequence sheet.

In the schedule sheet, on Monday to Friday, a specially-edited sequence and TV (in-house announcement) broadcast are alternately scheduled to be distributed at start time and end time while a DVD is reproduced, and on Sunday, only specially-edited sequence is scheduled to be consciously distributed.

In addition, the details of the specially-edited sequence which are set in the sequence sheet No. 1 include a number, broadcast time, name, path (location of the contents) and remarks.

Now, a flow of the broadcast program data in the conventional contents distribution system will be described with reference to FIG. 4.

The broadcast program data of which broadcast program is edited by the contents distribution service provider 1 is registered in the distribution server 11 through the communication line 5 such as the Internet and stored in the hard disk thereof.

The broadcast program data is distributed from the distribution server 11 through the communication line 5 such as the Internet to the hard disk of the distributing-site apparatus 3.

The display terminal of the distributing-site apparatus 3 executes, by contained reproducing program and control interface, a control of the display apparatus of the distribution-site apparatus 3 or a control of the source device, etc. which are subject to be controlled in accordance with a schedule as the broadcast program data, the contents and the control script.

In addition, there is proposed a contents distribution system capable of distributing contents with a simple operation of a user without large-capacity recording media and high-performance application. The contents distribution system has a management server apparatus communicating with a user terminal through a communication network, and the management server apparatus includes play list generation means for generating a play list of contents based on user's input to the user terminal, storage means for storing the generated play list in correspondence with the user, and transmission means for acquiring the play list from the storage means according to a request from the user terminal and transmitting the play list to the user terminal (see JP-A-2003-50588)

### SUMMARY

In general, a configuration of the distribution-site apparatus is not common in each distribution site. In the contents distribution system shown in FIGS. 1 to 4, there are several control methods such as input switching control of the display apparatus.

Therefore, in the contents distribution system, at the time of generating the broadcast program data, the different control scripts suitable for the different distributing-site apparatuses are edited, and the distribution process is performed with the broadcast program data including the different control scripts.

Accordingly, each of the distributing-site apparatuses needs to check the device configuration. In addition, although the details of the broadcast programs seem to be equal to each other, the control scripts must be generated so as to be suitable to the device configurations, and the distribution process must be performed with the broadcast program data including the control scripts. In addition, due to the difference of the device configurations, separate another broadcast programs is generated for the distribution process.

The present invention has been made in view of the above circumstances and provides a contents distribution system. According to an aspect of the invention, the contents distribution system includes; a distributing server storing broadcast program data including to-be-distributed contents, the broadcast program data comprising a broadcast program schedule; a distributing-site apparatus receiving the broadcast program data, the distributing-site apparatus comprising at least one file of a first device configuration file for a display apparatus and a second device configuration file for a source device, at least one file of the first and second device configuration files being controlled by the distributing-site apparatus; and a control server providing a unit controlling the distributing-site apparatus over a communication line. In an execution routine of the broadcast program schedule, when a control request for requesting for controlling at least one file of the controlled display apparatus and the controlled source device is acquired. At least one file of the first and second device configuration files is interpreted. Uniform Resource Locator (URL) constructed with a character sequence representing a logical configuration is generated from at least one interpreted file of the first and second device configuration files. A Web browser is operated to access to the control server to acquire a control I/F component. At least one of the display apparatus and the source device is controlled to reproduce the broadcast program data.

According to another aspect of the invention, there is provided a contents distribution method for a contents distribution system connecting a distributing server which stores broadcast program data including to-be-distributed contents, a distributing-site apparatus which receives the broadcast program data, and a control server which controls the distributing-site apparatus over a communication line, the method including: storing in the distributing-site apparatus at least one file of a first device configuration file for a display apparatus and a second device configuration file for a source device, the at least one file of the first and second device configuration file being controlled by the distributing-site apparatus; interpreting the at least one file of the first and second device configuration files and generating from the at least one file of the first and second device configuration files URL constructed with a character sequence representing a logical configuration, in an execution routine of a broadcast program schedule included in the broadcast program data, when a control request is acquired; operating a Web browser to access to the control server to acquire a control I/F component; and controlling at least one of the display apparatus and the source device by the acquired control I/F component.

According to another aspect of the invention, there is provided a storage medium readable by a computer, the storage medium storing a program of instructions executable by the computer of at least one of the control server and the distributing-site apparatus to perform a function for a contents distribution system connecting a distributing server which stores broadcast program data including to-be-distributed contents, a distributing-site apparatus which receives the broadcast program data, and the control server which controls the distributing-site apparatus over a communication line, the function, including: storing in the distributing-site apparatus at least one file of a first device configuration file for a display apparatus and a second device configuration file for a source device, at least one of the display apparatus and the source device being controlled by the distributing-site apparatus; interpreting at least one of the first and second device configuration files and generating from the at least one of the first and second device configuration files URL constructed with a character sequence representing a logical configuration, in an execution routine of a broadcast program schedule included in the broadcast program data, when a control request is acquired; operating a Web browser to access to the control server to acquire a control I/F component; and controlling at least one of the display apparatus and the source device by the acquired control I/F component.

According to another aspect of the invention, the URL has a configuration of “http://server_name/controlled_device_name/request_name.html?parameter . . . ”.

### BRIEF DESCRIPTION OF THE DRAWINGS

These and other objects and advantages of this invention will become more fully apparent from the following detailed description taken with the accompanying drawings in which:

FIG. 1 is a whole configuration of a contents distribution system according to a related art;

FIG. 2 is a hardware configuration of a contents distribution system according to another related art;

FIG. 3 is a view showing an example of a broadcast program schedule;

FIG. 4 is a view showing a block diagram of functions of a contents distribution system;

FIG. 5 is a use case view showing a flow of functions (data) in a broadband contents distribution system according to an embodiment;

FIG. 6 is a hardware configuration of a contents distribution system according to the embodiment;

FIG. 7 is a view showing a block diagram of functions of the contents distribution system according to the embodiment;

FIG. 8 is a flowchart showing a main routine of a contents distribution system according to the embodiment;

FIG. 9 is a flowchart showing a broadcast program data execution routine of a contents distribution system according to the embodiment;

FIG. 10 is a flowchart showing a control script execution routine of a contents distribution system according to the embodiment;

FIG. 11 is a flowchart showing a front stage of a configuration setting file generation routine in the contents distribution system according to the embodiment;

FIG. 12 is a flowchart showing a rear stage of the configuration setting file generation routine in the contents distribution system according to the embodiment;

FIG. 13 is a flowchart showing a control routine in the contents distribution system according to the embodiment;

FIG. 14 is a view showing an example of data flow (data relation) between a control server and a distributing-site apparatus in the contents distribution system according to the embodiment; and

FIG. 15 is an example of parameter DB in the contents distribution system according to the embodiment.

### DESCRIPTION OF THE EMBODIMENTS

Embodiments will be described with reference to the accompanying drawings.

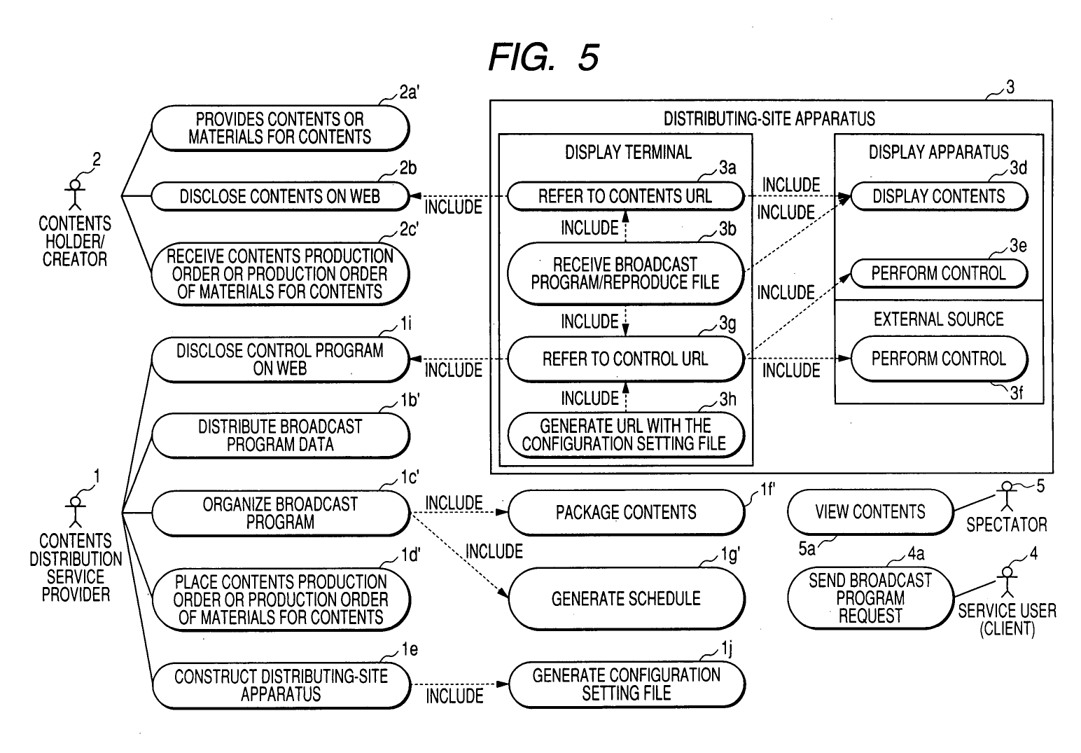

Whole configuration of a contents distribution system according to an embodiment will be described with reference to FIG. 5.

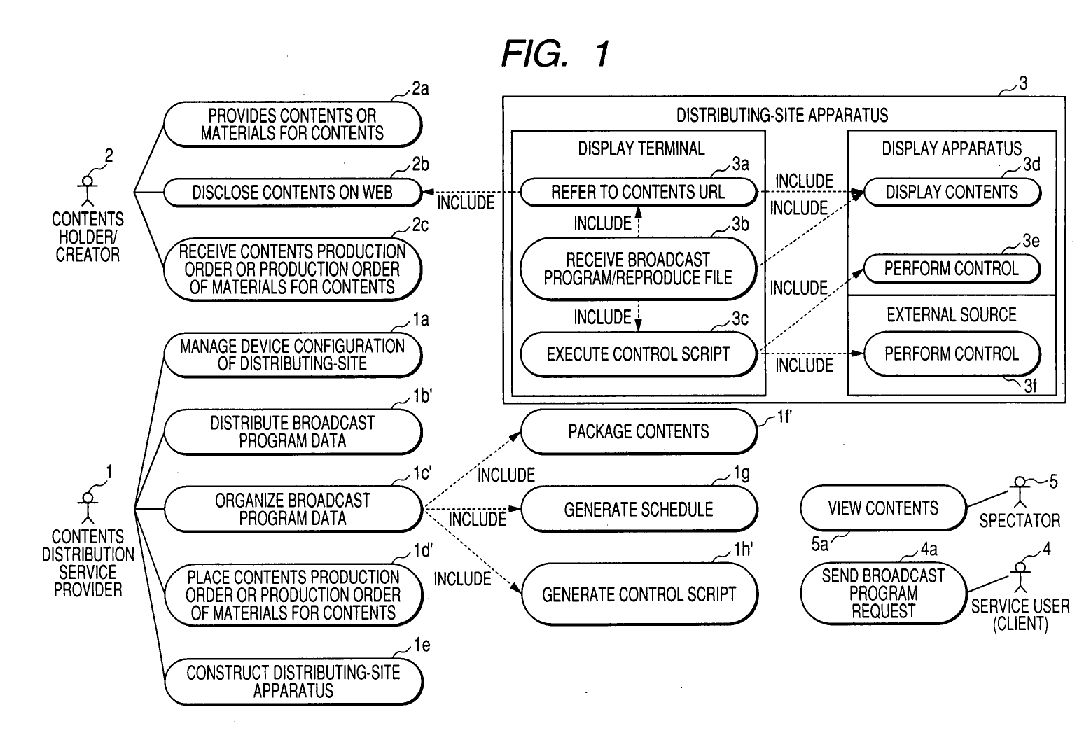

FIG. 5 is a use case view showing the contents distribution system. The same elements as those in FIG. 1 are denoted by the same reference numerals.

In FIG. 5, 1 denotes a contents distribution service provider, 2 denotes a contents holder or a creator, 3 denotes a distributing-site apparatus, 4 denotes a service user (client), and 5 denotes a spectator.

The contents holder or the creator 2 receives an order of contents production or an order of production of materials for the contents (2c), provides the contents or the materials for the contents (2a).

The contents holder 2 discloses a contents site on World-Wide Web in some cases (2b).

The contents distribution service provider 1 constructs a distributing-site apparatus (1e) and produces configuration setting file (1j).

In some cases, the contents distribution service provider 1 places the order of contents production or the order of the production of the materials for the contents (1d) and packages scattered contents (1f), produces a schedule (1g), organizes a broadcast program (1c), distributes the broadcast program data to the distribution-site apparatus 3 (1b).

The distributing-site apparatus 3 includes a display terminal and a display apparatus.

The display terminal receives broadcast program data, executes a schedule contained therein (3b), and reproduces the contents.

In case that a content of the contents is contents Uniform Resource Locator (hereinafter, referred Uniform Resource Locater as “URL”), the display terminal refers to a Web server indicated by the URL on Internet etc. via communication line. If a control of an external source is required, the display terminal analyzes the configuration setting file, produces a URL, and refers a control URL (3g).

The display apparatus and the external source etc. is controlled (3e, 3f), and display the contents (3d).

The contents distribution service user 4 sends a request for broadcast program to the contents distribution service provider (4a).

The spectator 5 views the contents displayed by the display apparatus (5a).

The contents distribution system according to the embodiment provides all the tasks associated with content distribution business in a one-stop manner.

According to the embodiment, the broadcast program data is edited and distributed by the contents distribution service provider. The broadcast program includes contents and schedule.

The contents are mainly classified into “contents file” (e.c. a still image, a moving image, a text for telop, and program) and “contents URL” referring to a Web server on network via communication line (e.c. Internet), and “external source” (e.c. TV broadcast or VTR/DVD players).

The schedule is configured by “sequence” instructing only an execution order without reference to absolute time and “program” executed in absolute time.

The device configuration of the distributing-site apparatus is recorded in a configuration setting file generated in the display terminal. When the contents (e.c. external source) is commanded according to the schedule, a URL is generated by combining the details of the request as “control request of the contents (e.c. external source)” and the details of the configuration setting file.

According to the embodiment, the URL also includes device configuration, so that it is unnecessary to separately manage the device configuration as distributing-site information.

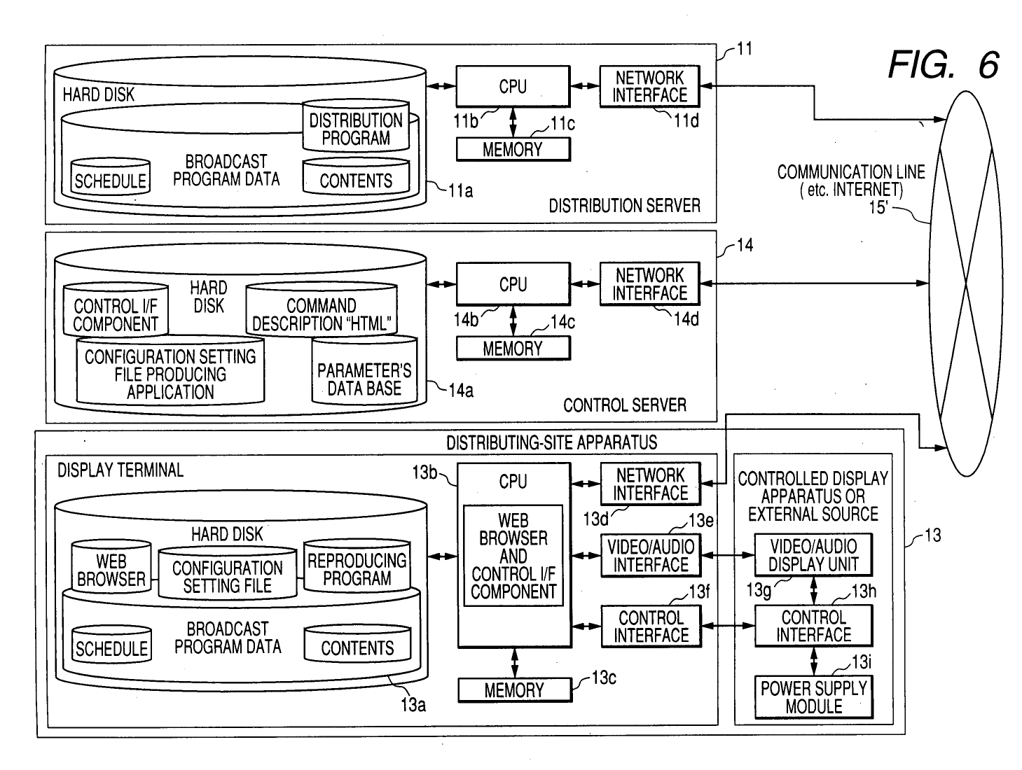

A hardware configuration of the contents distribution system acceding to the embodiment will be described with reference to FIG. 6.

In the contents distribution system, a distribution server 11, a control server 14, and a distributing-site apparatus 13 are connected through a communication line 15 such as the Internet.

The distribution server 11 includes a hard disk 11a, a CPU 11b, a memory 11c, and a network interface 11d.

The hard disk 11a includes a distribution program and broadcast program data, that is, schedule and contents files.

The distributing-site apparatus 13 includes a display terminal, a display apparatus, and an external source etc.

The display terminal includes a hard disk 13a, a CPU 13b, a memory 13c, a network interface 13d, a video/audio interface 13e, and a control interface 13f.

The display apparatus which is a controlled display apparatus or source device includes a video/audio display unit 13g, a control interface 13h, and a power supply module 13i.

The hard disk 13a stores a reproducing program, a Web browser, a configuration setting file, and broadcast program data, that is, schedule and contents files.

The control server 14 includes a hard disk 14a, a CPU 14b, a memory 14c, and a network interface 14d.

The hard disk 14a stores a control I/F (interface) component, a command description HTML (Hyper Text Markup Language), a configuration setting file generating application, and parameter DB.

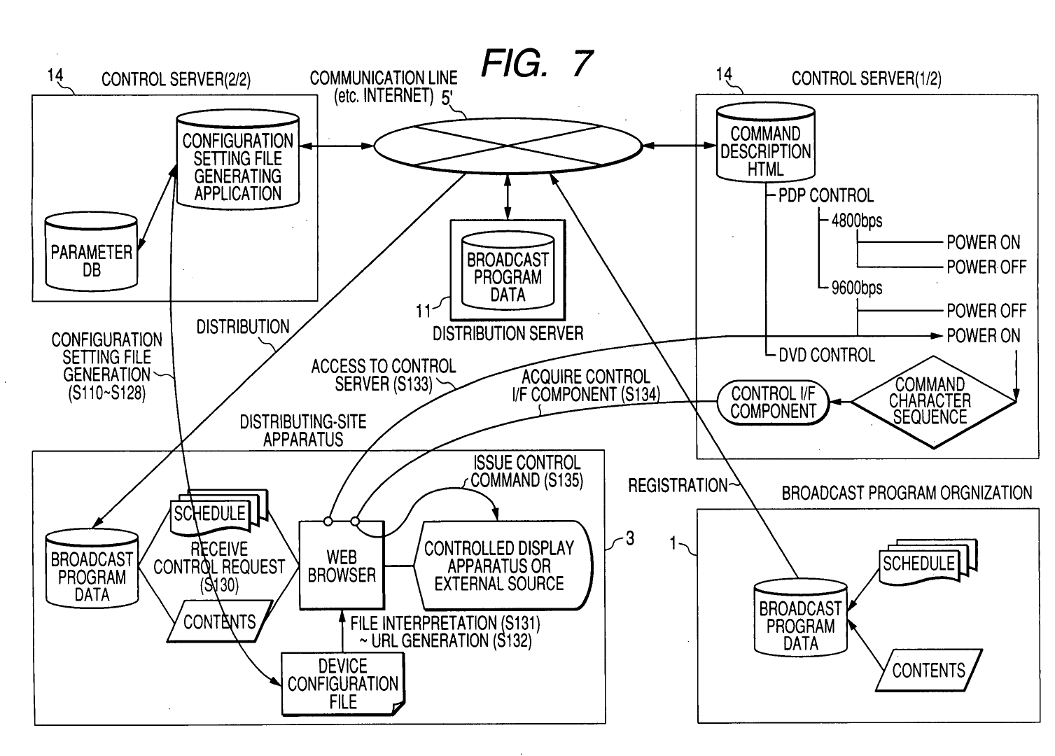

Now, a flow of the broadcast program data in the contents distribution system according to the embodiment will be described with reference to FIG. 7.

The contents distribution service provider 1 accesses application for producing the configuration setting file included in a control server 14 via communication line 5 (e.c. Internet), and produces the configuration setting file in the contents distribution-site apparatus 3.

The broadcast program data of which broadcast program is edited by the contents distribution service provider 1 is registered in the distribution server 11 through the communication line 5 such as the Internet and stored in the hard disk thereof.

The broadcast program data is distributed from the distribution server 11 through the communication line 5 such as the Internet to the hard disk of the distributing-site apparatus 3.

In the display terminal of the distributing-site apparatus 3, the broadcast program data includes the schedule and contents files (various image files and moving picture data).

The schedule indicates time-depending operation sequences or time-independent operation sequences. The operations includes “file reproducing” operations, “URL referring” operations, “control request” operations for indicating reproducing “external source” contents by TV broadcast or VTR/DVD players under the control of the display apparatus or source device, and other system operations.

The distributing-site apparatus interprets the device configuration file based on the configuration setting file generating application and the parameter DB stored in the control server to generate URL and issues a control command through a Web browser to perform controlling the controlled display apparatus or source device. This operation will be described later in detail.

According to a web browser and the configuration setting file, the distributing-site apparatus generates a control URL in accordance wit the contents, obtains a control I/F component from the control server 14 via the communication line 5 (e.c. Internet) by referring a URL, and executes a control of a device (e.c. external source) or a control of a display apparatus of the distributing-site apparatus. The device or the display apparatus of the distributing-site apparatus are subject to be controlled. (Hereinafter, described details)

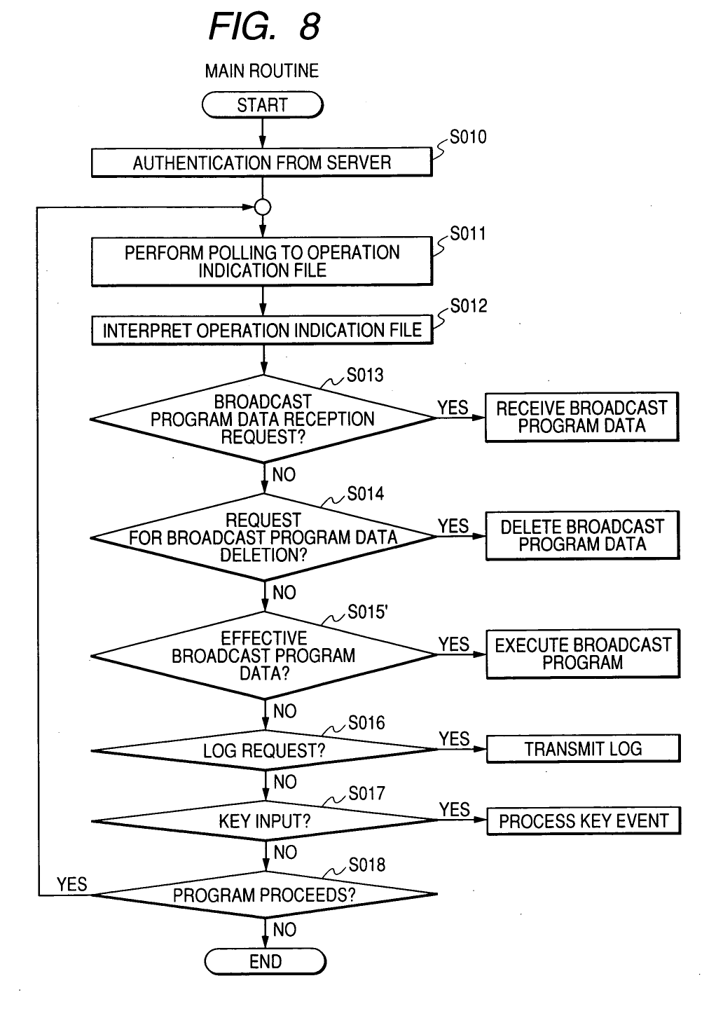

Now, operations (process sequence) of the contents distribution system according to the embodiment will be described with reference FIGS. 8 to 13.

FIG. 8 is a flowchart showing a main routine of the contents distribution system.

At the beginning of the operation thereof, the display terminal of the distributing-site apparatus accesses the distribution server on the network via the communication line (e.c. Internet) to receive authentication or time synchronization (S010).

In the distribution server, operation indication file corresponding to each display terminal of the distributing-site apparatus exist, and authenticated display terminal of the distributing-site apparatus starts polling for the files thereof (S011).

An operation instruction file acquired by the polling is interpreted (S012).

When there is a request of reception of a broadcast program data according to a result of the operation instruction file interpretation S012, a broadcast program data reception routine is executed, and a package of both download of the broadcast program data and the broadcast program data is decompressed, and the decompressed contents and schedule are set in a corresponding folder in the inside hard disk (S013).

When there is a broadcast program deleting request according to a result of the operation instruction file interpretation S012, it is determined whether or not there is a file corresponding to an effective broadcast program data, and after that, a broadcast program data deleting routine is executed (S014).

When an effective broadcast program data is currently indicated according to a result of the operation instruction file interpretation S012, a result of the broadcast program data receiving request routine S013 is checked. If the broadcast program data are constructed, the broadcast program data execution routine is performed, and if not, the broadcast program data receiving routine is executed (S015).

When there is a log request according to a result of the operation instruction file interpretation S012, log data stored in the display terminal of the distributing-site apparatus is transmitted to the distributing server via the communication line (e.c. Internet)(S016).

It is determined whether or not there is a key input from a user, and if there is a key input, a key-event process routine is performed (S017).

The proceeding of the program is determined based on return values from the routines. In case of the processing of the program, the operations repeat from operation indication file acquisition S011 (S018).

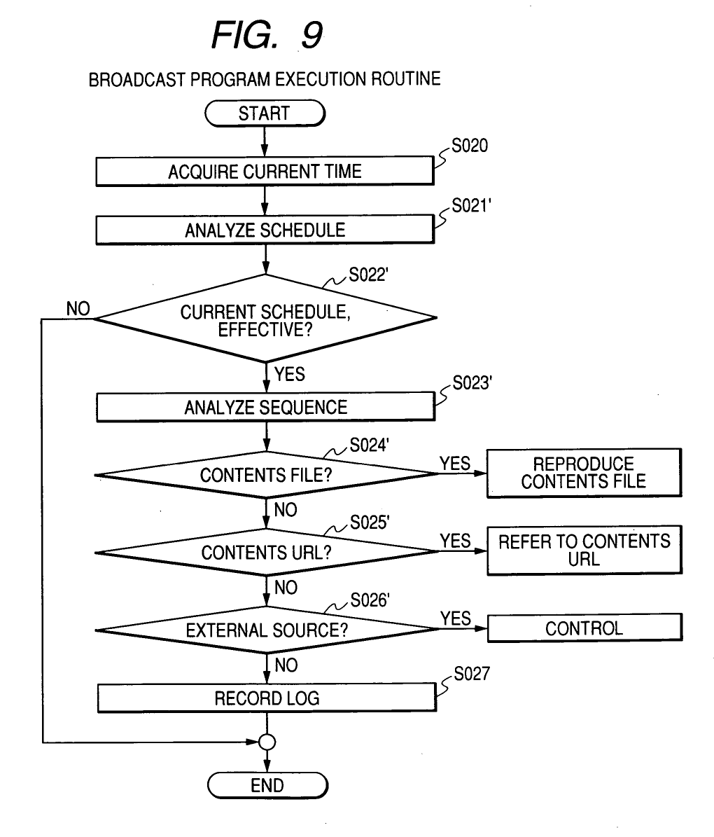

FIG. 9 is a flowchart showing a broadcast program data execution routine.

A current time point is acquired from a display terminal system clock of the distributing-site apparatus (S020).

A schedule file acquired from the broadcast program data reception routine S013 is interpreted (S021).

If there is not current-time effective schedule, the program ends without any execution (S022). If there is a current-time effective schedule, the details of the sequence are interpreted (S023).

If a result of the interpretation of the sequence S023 is “contents file reproducing”, a contents file reproducing routine for selecting a reproduction program in accordance with kinds of the contents file and compression format of still image and moving image is executed (S024).

If a result of the interpretation of the sequence S023 is “contents URL”, a contents URL referring routine for performing displaying Web contents is executed (S025).

If a result of the interpretation of the sequence S023 is “external source”, a control routine for constructing a control interface is executed (S026).

Results of the execution of the routines are recorded in a log (S027).

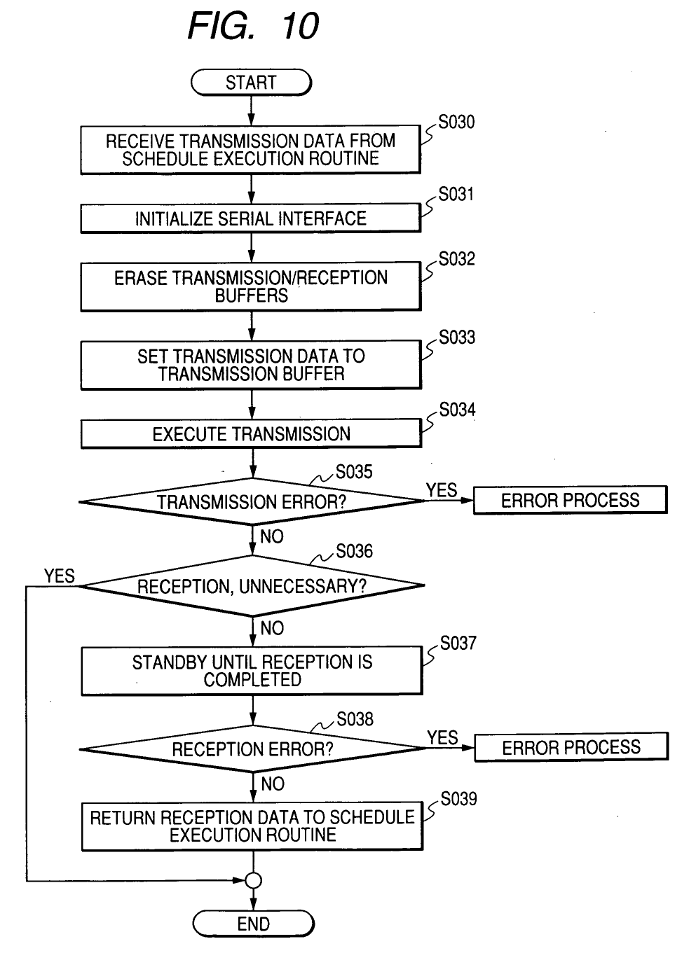

Here, a control script execution routine in a contents distribution system will be described with reference to FIG. 10 according to the embodiment.

Transmission data is acquired as a parameter from an external source determination portion S026 in the schedule execution routine (S030).

Serial-Interface initialization is performed with parameters such as a COM port number used or a transmission rate described in the control script contents (S031).

Previous data are cleared from transmission and reception buffers (S032).

Transmission data are set in the transmission buffer (S033).

Data transmission is performed (S034).

When transmission error occurs, an error process is performed (S035).

In a case where data reception is not needed at the interface initialization S031, the process ends (S036).

In a case where the data reception is needed, the standby is performed until the data reception is completed (S037).

In a case where a reception error including reception timeout occurs, the error process is performed (S038).

The control script executing routine ends with a return value of the reception data, and returning to the schedule execution routine is performed (S039).

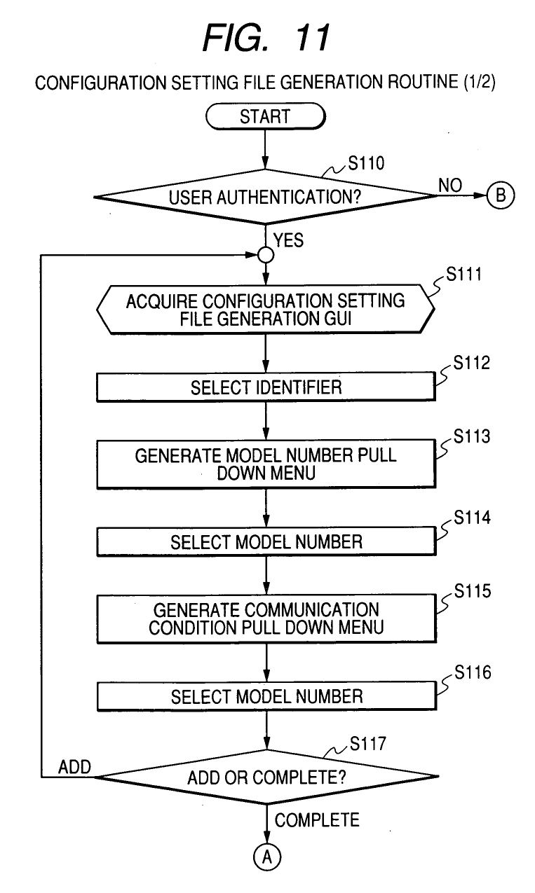

Now, a front stage of a configuration setting file generation routine of the contents distribution system according to the embodiment will be described with reference to a flowchart of FIG. 11. The configuration setting file generation routine is executed only when the distributing-site apparatus is constructed or when device configuration of the distributing-site apparatus is changed. The display terminal of the distributing-site apparatus operates a Web browser therein to access to a control server on network via communication line (e.c. Internet). If the user is authenticated, a configuration setting file generating application operates, and if not, the program ends (S110).

Hereinafter, control by a serial interface is exemplified.

The configuration setting file generating application generates a configuration setting file generation GUI having a device list including items such as identifier+ID, model number, COM port number, communication rate, parity, data bit number, and stop bit. At this time, a list of all the identifiers registered is acquired by querying the parameter DB, and the list of the registered identifiers are represented on an identifier pull-down menu. In addition, if there is a device list in advance, the device list is added to the list (S111).

Devices constituting the distributing-site apparatus are selected from the identifier pull-down menu (S112).

When the identifiers are selected, the configuration setting file generating application acquires all the model number corresponding to the selected identifiers by querying the parameter DB, and the model numbers are represented on the model number pull-down menu (S113).

The model numbers of the devices constituting the distributing-site apparatus are selected from the model number pull-down menu (S114).

If the model numbers are selected, the configuration setting file generating application acquires communication conditions of the selected model numbers by querying the parameter DB, and the communication conditions are represented on the following pull-down menus (communication rate, parity, data bit number, and stop bit) (S115).

If needed, the pull-down menus of the following communication conditions (communication rate, parity, data bit number, and stop bit) are selected (S116).

The distributing-site apparatus is constructed. If registration of all devices of which control is needed is completed, a completion button is pushed to proceed to a request registration step (S120), and if not, an addition button is pushed to repeat the steps from the step S111 (S117).

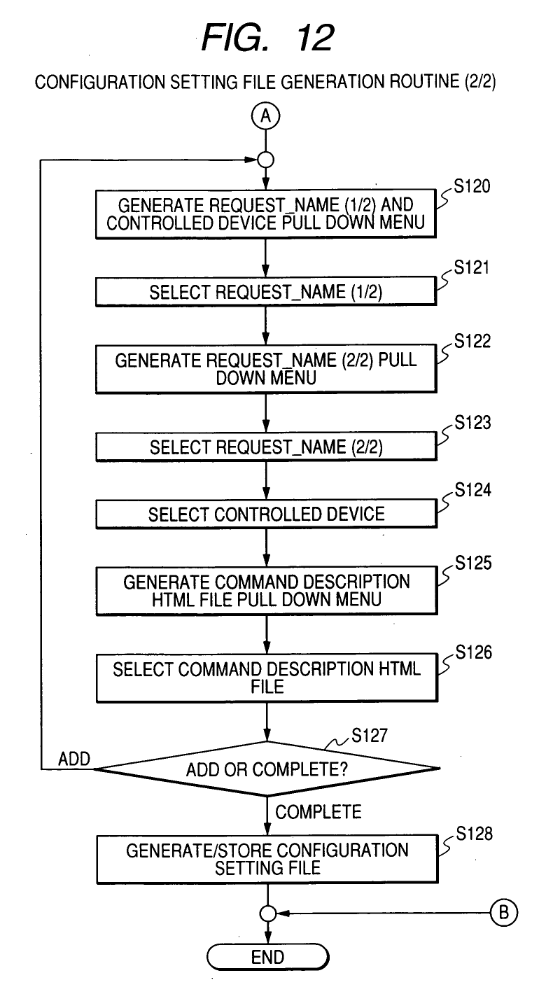

Now, a rear stage of the configuration setting file generation routine of the contents distribution system according to the embodiment will be described with reference to a flowchart of FIG. 12.

The configuration setting file generating application attaches a request list including the items such as request_name 1/2+request_name 2/2, controlled device, and command description HTML file name under the device list. At this time, a list of all the identifier+ID included in the device list is generated, and the identifier+ID list is represented on a request_name 1/2 pull-down menu and a controlled device pull-down menu (S120).

An identifier of a requested device designated at the time of editing broadcast program is selected from the request_name 1/2 pull-down menu (S121).

The configuration setting file generating application acquires all commands occupied by the identifiers selected from the request_name 1/2 by querying the parameter DB, and the commands are represented on the request_name 2/2 (S122).

A command of the request device designated at the time of editing broadcast program is selected from the request_name 2/2 pull-down menu (S123).

A device which is actually controlled is selected from the controlled device pull-down menu (S124).

The configuration setting file generating application specifies a model number from the device list based on the identifier selected as the controlled device and acquires a list of HTML file names where all the commands of the designated devices are described by querying the parameter DB, and the list of HTML file names are represented on the command description HTML file pull-down menu (S125).

Command description HTML files are selected from the command description HTML file pull-down menu (S126).

If registration of all needed requests is completed, a completion button is pushed, and if not, an addition button is pushed to repeat the steps from the step S120 (S127).

The set details are converted into an XML (extensible Markup Language) file. The file is stored in a predetermined folder in the display terminal, and the program ends (S128).

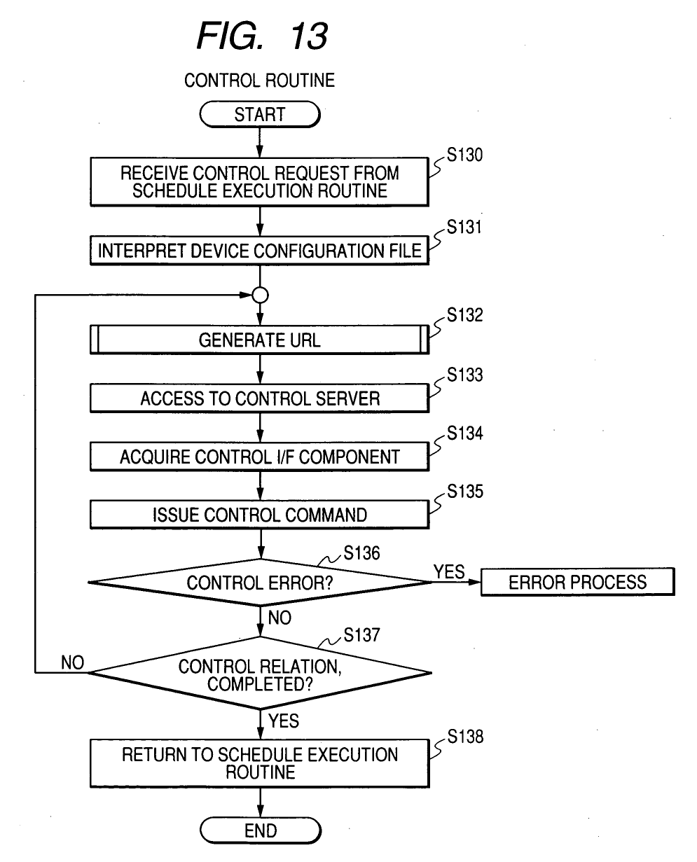

Now, a control routine of the contents distribution system according to the embodiment will be described with reference to a flowchart of FIG. 13.

A control request is acquired from the external source determination portion S026 in the schedule execution routine (S130).

The configuration setting file written in XML is interpreted, and device configuration or device information of the whole distributing-site apparatus is acquired to calculate the number of steps needed to execute the control request (S131).

The control server includes hierarchically-structured folders corresponding to types of devices or model numbers.

The folders store HTML flies corresponding to the number of command types, and the HTML files include description files for embedding control I/F components and files for description files of commands for the devices which are subject to be controlled.

The control server name included in the received control request S130 and the device name acquired from the interpretation S131 of the configuration setting file are combined, and the COM port or the transmission rate of the controlled device acquired from the interpretation S131 of the configuration setting file is combined as index parameters, so that an URL in a form of “http://server_name/controlled_device_name/device_name/request_name.html?parameter1&parameter2& . . . ” is generated (S132).

Accessing to the control server is performed (S133).

A control I/F component written in ActiveX+ASP or JavaBean+JSP together with the HTML file where the commands are written is embedded into the Web browser in the display terminal of the distributing-site apparatus (S134).

When the control I/F component is executed, commands are issued from a control interface of the display terminal of the distributing-site apparatus and transmitted to a controlled display apparatus or source device (S135).

In a case where a control error including reception timeout occurs, the error process is performed (S136).

It is determined whether or not all the steps obtained from the interpretation S131 of the configuration setting file are completed, and if there is a remaining step, the procedure repeats from the URL generation step S132 (S137).

The control routine ends, and the procedure returns to the schedule execution routine (S139).

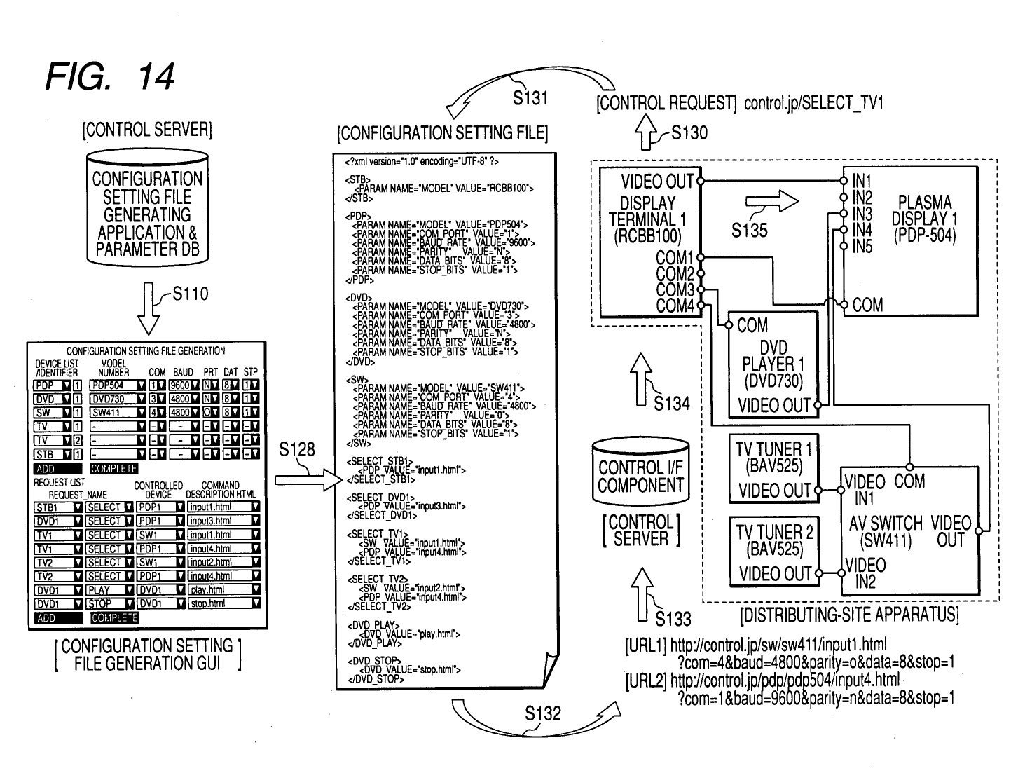

Now, an example of data flow (data relation) between the control server and the distributing-site apparatus in the contents distribution system according to the embodiment is shown in FIG. 14.

In FIG. 14, the procedure (steps) of FIGS. 11 to 13 to be executed mainly with the configuration stetting file is schematically shown.

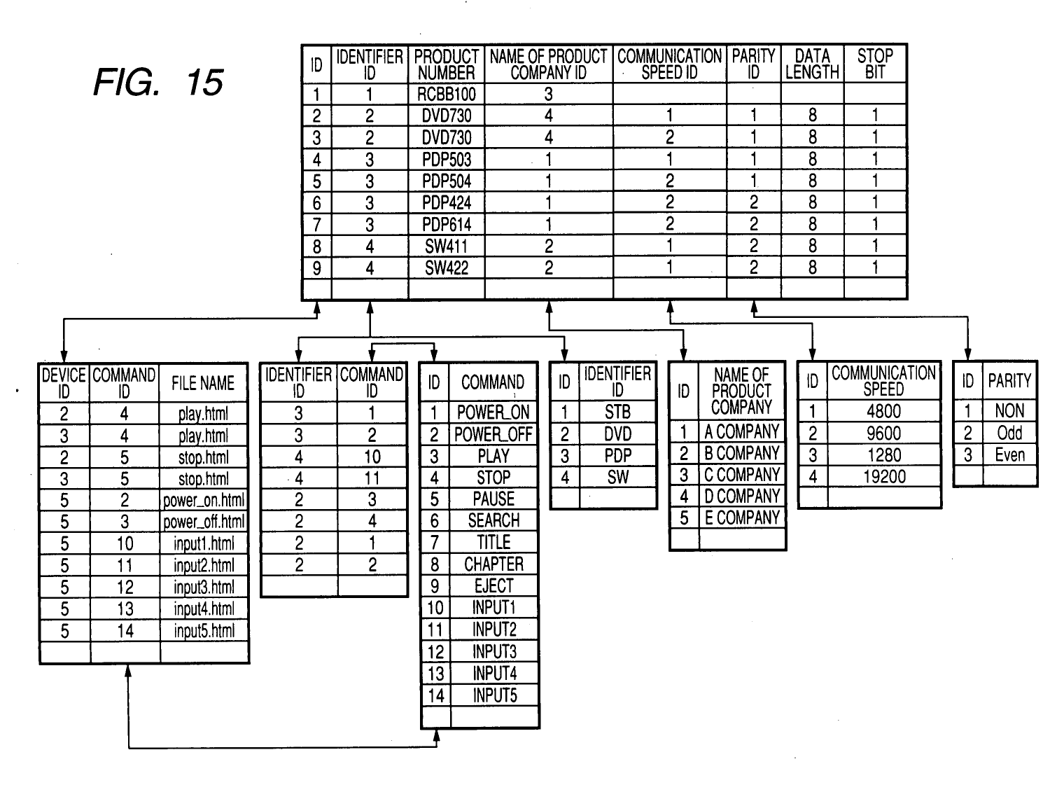

In addition, an example of the parameter DB in the contents distribution system according to the embodiment is shown in FIG. 15.

According to the embodiment, a contents distribution apparatus includes procedures of: embedding different physical configurations of different distributing sites in a file describing a conversion table in a display terminal of a distributing-site apparatus; converting the configuration into a character sequence representing a logical configuration; disposing a program for performing actual control on the Web instead of distributing the program so as to allow accessing by using the character sequence representing a logical configuration as “URL”; and providing a control program suitable to the accessing, so that it is possible to commonly use the broadcast program data without checking configurations of distributing-site apparatuses irrespective of difference of physical configurations between distributing-sites.

[FIG. 1]

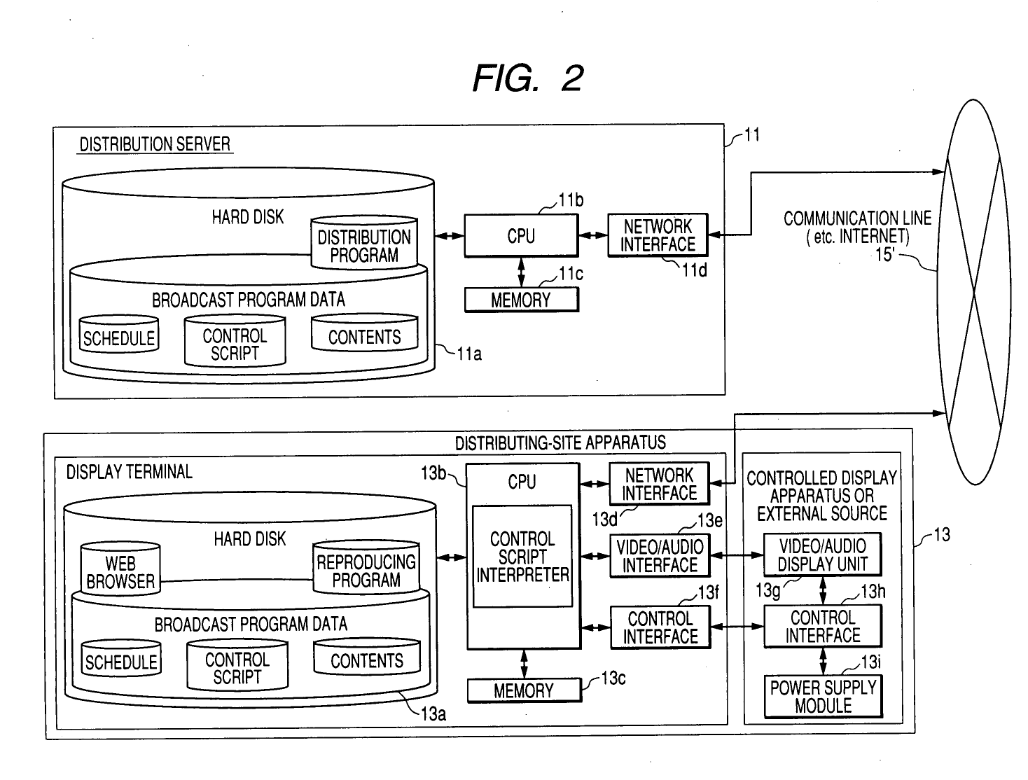

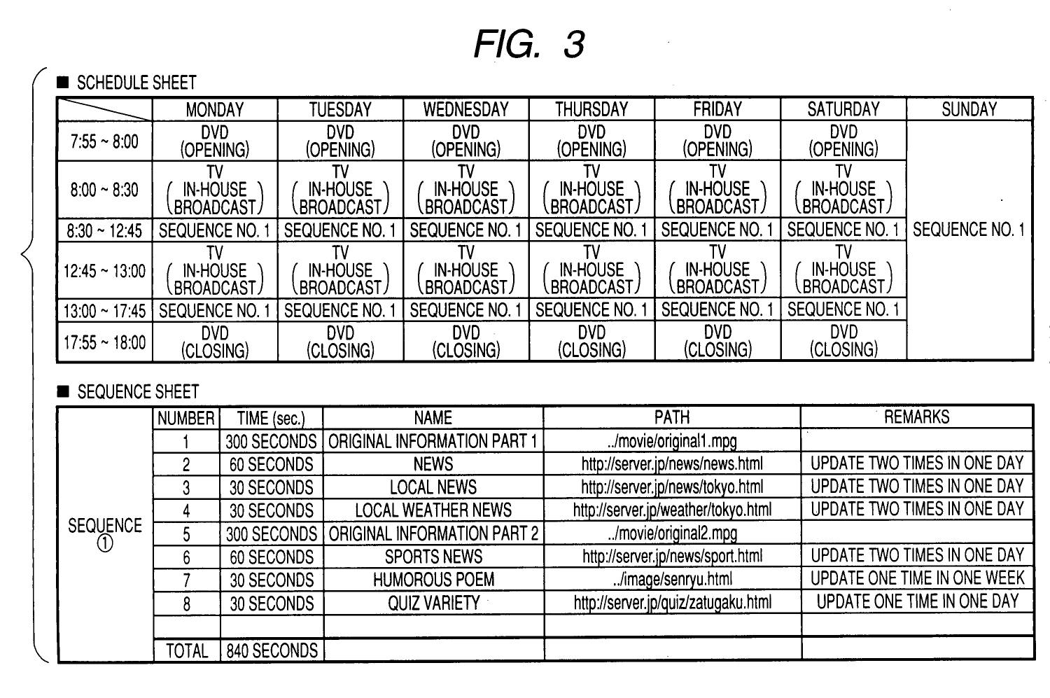

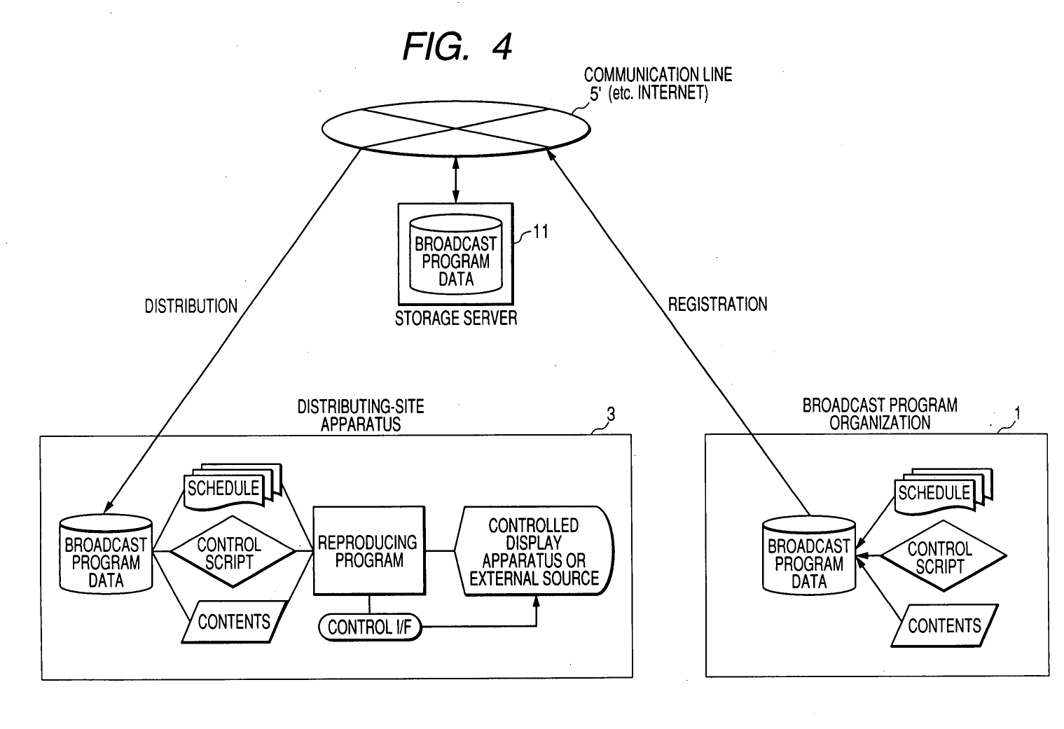

1. CONTENTS DISTRIBUTION SERVICE PROVIDER
1a. MANAGE DEVICE CONFIGURATION OF DISTRIBUTING-SITE
1b′. DISTRIBUTE BROADCAST PROGRAM DATA
1c′. ORGANIZE BROADCAST PROGRAM DATA
1d′. PLACE CONTENTS PRODUCTION ORDER OR PRODUCTION ORDER OF MATERIALS FOR CONTENTS
1e. CONSTRUCT DISTRIBUTING-SITE APPARATUS
1f′. PACKAGE CONTENTS
1g. GENERATE SCHEDULE
1h′. GENERATE CONTROL SCRIPT
2. CONTENTS HOLDER/CREATOR
2a′. PROVIDES CONTENTS OR MATERIALS FOR CONTENTS
2b. DISCLOSE CONTENTS ON WEB
2c′. RECEIVE CONTENTS PRODUCTION ORDER OR PRODUCTION ORDER OF MATERIALS FOR CONTENTS
3a. REFER TO CONTENTS URL
3b. RECEIVE BROADCAST PROGRAM/REPRODUCE FILE
3c. EXECUTE CONTROL SCRIPT
3d. DISPLAY CONTENTS
3e. PERFORM CONTROL
3f. PERFORM CONTROL
4. SERVICE USER (CLIENT)
4a. SEND BROADCAST PROGRAM REQUEST
5. SPECTATOR
5a. VIEW CONTENTS
a. DISTRIBUTING-SITE APPARATUS
b′. EXTERNAL SOURCE
c. DISPLAY TERMINAL
d. DISPLAY APPARATUS
e. INCLUDE
   [FIG. 2]
a. DISTRIBUTION SERVER
b. HARD DISK
c. SCHEDULE
d. CONTROL SCRIPT
e. DISTRIBUTION PROGRAM
f′. CONTENTS
g. BROADCAST PROGRAM DATA
9. CPU
11c. MEMORY
11d. NETWORK INTERFACE
15′. COMMUNICATION LINE (e.c. INTERNET)
h. DISTRIBUTING-SITE APPARATUS
i. DISPLAY TERMINAL
j. WEB BROWSER
k. REPRODUCING PROGRAM
l. CONTROL SCRIPT INTERPRETER
m′. CONTROLLED DISPLAY APPARATUS OR EXTERNAL SOURCE
13c. MEMORY
13d. NETWORK INTERFACE
13e. VIDEO/AUDIO INTERFACE
13f. CONTROL INTERFACE
13g. VIDEO/AUDIO DISPLAY UNIT
13h. CONTROL INTERFACE
13i. POWER SUPPLY MODULE
   [FIG. 3]
a. SCHEDULE SHEET
b. MONDAY
c. TUESDAY
d. WEDNESDAY
e. THURSDAY
f. FRIDAY
g. SATURDAY
h. SUNDAY
i-1. OPENING
i-2. IN-HOUSE BROADCAST
i-3. SEQUENCE NO. 1
i-4. CLOSING
j′. SEQUENCE SHEET
k′. NAME
l′. PATH
m. TIME (sec.)
n.′ REMARKS
o′. NUMBER
p′. ORIGINAL INFORMATION PART 1
q′. NEWS
r′. LOCAL NEWS
s′. LOCAL WEATHER NEWS
t′. ORIGINAL INFORMATION PART 2
u′. SPORTS NEWS
v′. HUMOROUS POEM
w′. QUIZ VARIETY
x. TOTAL
y. SECONDS
z. SEQUENCE \hat{1}
a-1. UPDATE TWO TIMES IN ONE DAY
a-2. UPDATE ONE TIME IN ONE WEEK
a-3. UPDATE ONE TIME IN ONE DAY
   [FIG. 4]
5′. COMMUNICATION LINE (etc. INTERNET)
11. BROADCAST PROGRAM DATA
a. STORAGE SERVER
b. DISTRIBUTION
c. DISTRIBUTING-SITE APPARATUS
d. BROADCAST PROGRAM ORGANIZATION
e. SCHEDULE
f. BROADCAST PROGRAM DATA
g. CONTROL SCRIPT
h′. CONTENTS
i. REPRODUCING PROGRAM
j. CONTROL I/F
k′. CONTROLLED DISPLAY APPARATUS OR EXTERNAL SOURCE
16. BROADCAST PROGRAM DATA
17. SCHEDULE
18. CONTROL SCRIPT
19. CONTENTS/MATERIALS
   [FIG. 5]
1. CONTENTS DISTRIBUTION SERVICE PROVIDER
1a. MANAGE DEVICE CONFIGURATION OF DISTRIBUTING-SITE
1b′. DISTRIBUTE BROADCAST PROGRAM DATA
1c. ORGANIZE BROADCAST PROGRAM
1d′. PLACE CONTENTS PRODUCTION ORDER OR PRODUCTION ORDER OF MATERIALS FOR CONTENTS
1e. CONSTRUCT DISTRIBUTING-SITE APPARATUS
1f. GENERATE CONTROL SCRIPT
1g. GENERATE SCHEDULE
1h. EMBED CONTENTS/MATERIALS/URL
1i. DISCLOSE CONTROL PROGRAM ON WEB
2. CONTENTS HOLDER/CREATOR
2a′. PROVIDES CONTENTS OR MATERIALS FOR CONTENTS
2b. DISCLOSE CONTENTS ON WEB
2c′. RECEIVE CONTENTS PRODUCTION ORDER OR PRODUCTION ORDER OF MATERIALS FOR CONTENTS
3a. REFER TO CONTENTS URL
3b. RECEIVE BROADCAST PROGRAM/REPRODUCE FILE
3c. EXECUTE CONTROL SCRIPT
3d. DISPLAY CONTENTS
3e. PERFORM CONTROL
3f. PERFORM CONTROL
4. SERVICE USER (CLIENT)
4a. SEND BROADCAST PROGRAM REQUEST
5. SPECTATOR
5a. VIEW CONTENTS
a. DISTRIBUTING-SITE APPARATUS
b. EXTERNAL SOURCE
c. DISPLAY TERMINAL
d. DISPLAY APPARATUS
e. INCLUDE
   [FIG. 6]
a. DISTRIBUTION SERVER
b. HARD DISK
c. SCHEDULE
d. CONTROL SCRIPT
e. DISTRIBUTION PROGRAM
f′. CONTENTS
g. BROADCAST PROGRAM DATA
9. CPU
11c. MEMORY
11d. NETWORK INTERFACE
15′. COMMUNICATION LINE (e.c. INTERNET)
h. DISTRIBUTING-SITE APPARATUS
i. DISPLAY TERMINAL
j. WEB BROWSER
k. REPRODUCING PROGRAM
l. CONTROL SCRIPT INTERPRETER
m. CONTROLLED DISPLAY APPARATUS OR EXTERNAL SOURCE
n. CONFIGURATION SETTING FILE
o. CONTROL I/F COMPONENT
p. COMMAND DESCRIPTION “HTML”
q. CONFIGURATION SETTING FILE PRODUCING APPLICATION
r. PARAMETER'S DATA BASE
s. CONTROL SERVER
13b. WEB BROWSER AND CONTROL I/F COMPONENT
13c. MEMORY
13d. NETWORK INTERFACE
13e. VIDEO/AUDIO INTERFACE
13f. CONTROL INTERFACE
13g. VIDEO/AUDIO DISPLAY UNIT
13h. CONTROL INTERFACE
13i. POWER SUPPLY MODULE
14c. MEMORY
14d. NETWORK INTERFACE
   [FIG. 7]
a-1. CONTROL SERVER(2/2)
a-2. CONTROL SERVER(1/2)
5′. COMMUNICATION LINE (e.c. INTERNET)
b. PARAMETER DB
c. CONFIGURATION SETTING FILE GENERATING APPLICATION
d. CONFIGURATION SETTING FILE GENERATION
e. DISTRIBUTING-SITE APPARATUS
f. SCHEDULE
g. BROADCAST PROGRAM DATA
h. RECEIVE CONTROL REQUEST
i′. CONTENTS
j. WEB BROWSER
k. DEVICE CONFIGURATION FILE
l. FILE INTERPRETATION (S131)
m. URL GENERATION (S132)
o. CONTROLLED DISPLAY APPARATUS OR EXTERNAL SOURCE
p. ISSUE CONTROL COMMAND
q. ACQUIRE CONTROL I/F COMPONENT
r. ACCESS TO CONTROL SERVER
s. DISTRIBUTION SERVER
t. COMMAND DESCRIPTION HTML
u. PDP CONTROL
v. DVD CONTROL
w. CONTROL I/F COMPONENT
x. COMMAND CHARACTER SEQUENCE
y. BROADCAST PROGRAM ORGNIZATION
z. REGISTRATION
   [FIG. 8]
a. START
b. MAIN ROUTINE
c. NO
d. YES
e. RECEIVE BROADCAST PROGRAM DATA
f. DELETE BROADCAST PROGRAM DATA
g. EXECUTE BROADCAST PROGRAM
h. TRANSMIT LOG
i. PROCESS KEY EVENT
j. END
S010. AUTHENTICATION FROM SERVER
S011. PERFORM POLLING TO OPERATION INDICATION FILE
S012. INTERPRET OPERATION INDICATION FILE
S013. BROADCAST PROGRAM DATA RECEPTION REQUEST?
S014. REQUEST FOR BROADCAST PROGRAM DATA DELETION
S015′. EFFECTIVE BROADCAST PROGRAM DATA?
S016. LOG REQUEST?
S017. KEY INPUT?
S018. PROGRAM PROCEEDS?
   [FIG. 9]
a. BROADCAST PROGRAM EXECUTION ROUTINE
b. START
c′. REPRODUCE CONTENTS FILE
d′. REFER TO CONTENTS URL
e. CONTROL
f. END
g. YES
h. NO
S020. ACQUIRE CURRENT TIME
S021′. ANALYZE SCHEDULE
S022′ CURRENT SCHEDULE, EFFECTIVE?
S023′. ANALYZE SEQUENCE
S024′. CONTENTS FILE?
S025′. CONTENTS URL?
S026′. EXTERNAL SOURCE?
S027. RECORD LOG
   [FIG. 10]
b. START
c. ERROR PROCESS
d. END
e. YES
f. NO
S030. RECEIVE TRANSMISSION DATA FROM SCHEDULE EXECUTION ROUTINE
S031. INITIALIZE SERIAL INTERFACE
S032. ERASE TRANSMISSION/RECEPTION BUFFERS
S033. SET TRANSMISSION DATA TO TRANSMISSION BUFFER
S034. EXECUTE TRANSMISSION
S035. TRANSMISSION ERROR?
S036. RECEPTION, UNNECESSARY?
S037. STANDBY UNTIL RECEPTION IS COMPLETED
S038. RECEPTION ERROR?
S039. RETURN RECEPTION DATA TO SCHEDULE EXECUTION ROUTINE
   [FIG. 11]
a. CONFIGURATION SETTING FILE GENERATION ROUTINE 1/2
b. START
S110. USER AUTHENTICATION?
S111. ACQUIRE CONFIGURATION SETTING FILE GENERATION GUI
S112. SELECT IDENTIFIER
S113. GENERATE MODEL NUMBER PULL DOWN MENU
S114. SELECT MODEL NUMBER
S115. GENERATE COMMUNICATION CONDITION PULL DOWN MENU
S116. SELECT MODEL NUMBER
S117. ADD OR COMPLETE?
c. ADD
d. COMPLETE
e. YES
f. NO
   [FIG. 12]
a. CONFIGURATION SETTING FILE GENERATION ROUTINE 2/2
S120. GENERATE REQUEST_NAME 1/2 AND CONTROLLED DEVICE PULL DOWN MENU
S121. SELECT REQUEST_NAME 1/2
S122. GENERATE REQUEST_NAME 2/2 PULL DOWN MENU
S123. SELECT REQUEST_NAME 2/2
S124. SELECT CONTROLLED DEVICE
S125. GENERATE COMMAND DESCRIPTION HTML FILE PULL DOWN MENU
S126. SELECT COMMAND DESCRIPTION HTML FILE
S127. ADD OR COMPLETE?
S128. GENERATE/STORE CONFIGURATION SETTING FILE
b. END
c. ADD
d. COMPLETE
   [FIG. 13]
a. CONTROL ROUTINE
b. START
c. ERROR PROCESS
d. END
e. NO
f. YES
S130. RECEIVE CONTROL REQUEST FROM SCHEDULE EXECUTION ROUTINE
S131. INTERPRET DEVICE CONFIGURATION FILE
S132. GENERATE URL
S133. ACCESS TO CONTROL SERVER
S134. ACQUIRE CONTROL I/F COMPONENT
S135. ISSUE CONTROL COMMAND
S136. CONTROL ERROR?
S137. CONTROL RELATION, COMPLETED?
S138. RETURN TO SCHEDULE EXECUTION ROUTINE
   [FIG. 14]
a. CONTROL SERVER
b. CONFIGURATION SETTING FILE GENERATING APPLICATION & PARAMETER DB
c. CONFIGURATION SETTING FILE GENERATION
d. DEVICE LIST/IDENTIFIER
e. MODEL NUMBER
f. REQUEST LIST
g. REQUEST_NAME
h. CONTROLLED DEVICE
i. COMMAND DESCRIPTION HTML
j. CONFIGURATION SETTING FILE GENERATION GUI
k. add
l. complete
m. CONFIGURATION SETTING FILE
n. CONTROL REQUEST
o. PLASMA DISPLAY
p. DVD PLAYER
q. TV TUNER 1
r. TV TUNER 2
s. AV SWITCH
t. CONTROL I/F COMPONENT
u. CONTROL SERVER
v. DISTRIBUTING-SITE APPARATUS
w. DISPLAY TERMINAL
   [FIG. 15]
a. identifier ID
b. product number
c. name of product company
d. communication speed
e. parity
f. data length
g. stop bit
h. device ID
i. command ID
j. file name
k. command ID
l. command
m. command that identifier includes
n. A company
o. B company
p. C company
q. D company
r. E company

What is claimed is:

1. A contents distribution system comprising:
a distributing server storing broadcast program data including to-be-distributed contents, the broadcast program data comprising a broadcast program schedule;
a distributing-site apparatus receiving the broadcast program data, the distributing-site apparatus comprising at least one file of a first configuration setting file for a display apparatus and a second configuration setting file for an external source, at least one file of the first and second configuration setting files being controlled by the distributing-site apparatus; and
a control server providing a unit controlling the distributing-site apparatus over a communication line,
wherein in an execution routine of the broadcast program schedule, when a control request for requesting for controlling at least one of the display apparatus and the external source which is a subject to be controlled,
at least one file of the first and second configuration setting files is interpreted,
Uniform Resource Locator (URL) constructed with a character sequence representing a logical configuration is generated from the at least one interpreted file of the first and second configuration setting files,
a Web browser is operated to access to the control server to acquire a control I/F component, and
the at least one of the display apparatus and the external source is controlled to reproduce the received broadcast program data.

2. A contents distribution method for a contents distribution system connecting a distributing server which stores broadcast program data including to-be-distributed contents, a distributing-site apparatus which receives the broadcast program data, and a control server which controls the distributing-site apparatus over a communication line, the method comprising:
storing in the distributing-site apparatus at least one file of a first configuration file for a display apparatus and a second configuration file for an external source, the at least one file of the first and second device configuration file being controlled by the distributing-site apparatus;
interpreting the at least one file of the first and second configuration setting files and generating from the at least one file of the first and second configuration setting files URL constructed with a character sequence representing a logical configuration, in an execution routine of a broadcast program schedule included in the broadcast program data, when a control request for controlling at least one of the display apparatus and the external source which is a subject to be controlled, is acquired;
operating a Web browser to access to the control server to acquire a control I/F component; and
controlling at least one of the display apparatus and the external source by the acquired control I/F component.

3. A storage medium readable by a computer, the storage medium storing a program of instructions executable by the computer of at least one of the control server and the distributing-site apparatus to perform a function for a contents distribution system connecting a distributing server which stores broadcast program data including to-be-distributed contents, a distributing-site apparatus which receives the broadcast program data, and the control server which controls the distributing-site apparatus over a communication line, the function, comprising:
storing in the distributing-site apparatus a configuration setting file describing at least one of a configuration of a display apparatus and a configuration of an external source, at least one of the display apparatus and the external source being controlled by the distributing-site apparatus;
interpreting the configuration setting file and generating from the at least one of the first and second device configuration files URL constructed with a character sequence representing a logical configuration, in an execution routine of a broadcast program schedule included in the broadcast program data, when a control request for controlling at least one of the display apparatus and the external source is acquired;
operating a Web browser to access to the control server to acquire a control I/F component; and
controlling at least one of the display apparatus and the external source by the acquired control I/F component.

4. A storage medium readable by a computer, according to claim 3, wherein the URL has a configuration of “http://server_name/controlled_device_name/request_name.html?parameter . . . ”.

5. The contents distribution system according to claim 1, wherein the first configuration setting file for a display apparatus and the second configuration setting file for an external source is configured by one configuration setting file.
